(19) United States
(12) Patent Application Publication
(10) Pub. No.: US 2008/0203717 A1
(43) Pub. Date: Aug. 28, 2008

(54) Rollover protection system for motor vehicles with an actively deployable rollover body

(75) Inventors: Michael Helsper, Siegen (DE); Helmut Kretschmann, Altena (DE); Gurkan Beki, Engelskirchen (DE); Marius Hoika, Bergneustadt (DE)

Correspondence Address: FLASTER/GREENBERG P.C.;8 PENN CENTER, 1628 JOHN F. KENNEDY BLVD., 15TH FLOOR, PHILADELPHIA, PA, 19103, US

(73) Assignee: Automotive Group ISE Innomotive Systems Europe GmbH, Bergneustadt (DE)

(21) Appl. No.: 12/012,687

(22) Filed: Feb. 4, 2008

(30) Foreign Application Priority Data
Feb. 3, 2007 (DE) 10 2007 005 517.1

(51) Int. Cl. B60R 21/13

(52) U.S. Cl. 280/756

(57) ABSTRACT

The invention relates to a rollover protection system for motor vehicles with at least one rollover body that in a normal state can be held by means of a holding mechanism in a lower, stored resting position and can be brought in a sensor-controlled manner into a deployed, locked protective position, with release of the holding mechanism. In such rollover protection systems, in order to minimize in a simple manner the mechanical stress on the bearing points of the rollover body or of the locking mechanism in the protective position arising in a rollover, the invention provides that at least one deformation element is integrated into rollover body, formed from at least two elastic and/or plastic deformation-defined, energy-reducing partial elements of the rollover body that can be slid into one another. The rollover body has two bar arms, at least one of which has at least two arm elements that can be slid into one another as partial elements of the rollover body for the deformation element.

### BACKGROUND OF THE INVENTION

1. Field of the Invention

The invention relates to a rollover protection system for motor vehicles with at least one rollover body that in a normal state can be held by a holding mechanism in a lower, stored resting position and can be brought in a sensor-controlled manner into a deployed, locked supporting position, with release of the holding mechanism by means of a drive.

2. Description of Related Art

Such rollover protection systems are for protecting passengers in motor vehicles without a protective roof, typically in convertibles or sports cars, by creating a survival area for the passengers in a rollover.

It is known to provide a roll bar permanently integrated into the body and extending the entire width of the motor vehicle, or to assign to each vehicle seat a permanently installed roll bar. Both solutions relate to a so-called rigid roll bar, that is a roll bar that is permanently mounted in the support position, and not first deployed from a stored resting position to a deployed support position in the event of an imminent rollover. Thus, in order to create a sufficient survival area, the bar heads of the roll bars project relatively high above the back rest of the vehicle seats, which is felt to be obtrusive especially in convertibles.

On the market, constructive solutions for so-called active roll bars are increasingly prevalent, in which the roll bar is normally stored, and only when a dangerous situation occurs such as an imminent rollover, a sensor causes it to be quickly deployed to a protective position by means of a then activated drive, so as to prevent the passengers from being crushed when the motor vehicle rolls over.

These solutions typically have a roll bar for each seat, either U-shaped or formed as a shaped element, that is linearly guided within a cassette housing affixed to the vehicle, and the roll bar is normally held by a holding device in a lower, resting position against the spring tension of a drive pressure spring, and the roll bar can be moved into an upper, supportive position in a rollover in response to a sensor by means of the spring force when the holding device releases. Meanwhile, a locking device that engages prevents the roll bar from being pressed back into the cassette.

The holding device typically has a holding element attached to the rollover body that is in detachable mechanical active connection with the triggering element of a sensor-controlled trigger system, which typically is formed by a trigger magnet, the so-called crash magnet, or by a pyrotechnic trigger element.

The locking mechanism, also called a retraction lock, typically consists of a swingably articulated, spring-loaded detent pawl with tooth segments with a fixed tooth strip, a latch arbor or the like, whereby, depending on the design, one locking element is connected to the roll bar, and the other is affixed to the vehicle.

Such a cassette construction of a seat-related rollover protection system with a linearly deploying U-shaped roll bar is for example disclosed in DE 100 40 642 C1.

A corresponding cassette system with shaped elements as rollover elements and a cassette uptake is shown in DE 198 38 989 C1.

In addition to cassette designs, active rollover protection systems are also known that use a rear wall principle and have a rear wall assembly as for example described in DE 103 44 446 B3. Such a system has a frame construction, positioned between the rear passenger compartment and the trunk, consisting on the one hand of a shaped cross member permanently affixed to the body and extending across the inner width of the vehicle that has guiding means for the bar arms of two adjacent, U-shaped roll bars, and consisting on the other hand of shaped member elements extending vertically downward with a floor part for receiving the usual components of the extendable rollover protection system such as the trigger magnet for the sensor-controlled triggering of the extension motion of the roll bars, and the drive pressure springs. It is also known to integrate two cassette systems into one backrest member, each with one active roll bar (DE 100 44 926 C1).

Both the cassette designs and cross member designs have been introduced to the market and are used in many embodiments adapted to the respective vehicle type.

However, rollover protection systems are also known that have an actively deployable roll bar that extends across nearly the entire width of the vehicle. The bar head can be designed as a continuous bar shell (DE 195 40 819 A1) or as a cross yoke according to DE 197 12 955 A1, or it can have bar-head-like shaped regions in a cross yoke in the area of the vehicle seats (DE 100 44 930 C1).

Other designs of deployable roll bars are also known in the prior art. For example, DE 101 43 934 A1 discloses an active foldable or collapsible roll bar, formed by a rollover cross-yoke extending horizontally almost across the width of the motor vehicle and by two arm elements that are held at one end in a longitudinally sliding manner in the cross yoke and, at the other end of each, are articulated to the body in a rotating manner, under spring tension from a torsion spring.

In the stored rest position of the rollover cross yoke, the two arm elements are held face-to-face axially in sequence in the rollover cross yoke. In case of a crash, they are deployed by the two torsion springs into the support position with the roll bar as a whole being folded upward or swung open.

This known construction of a folding bar cannot be used, however, with seat-related active roll bars. The swingable arm elements lie axially in sequence in the stored state. Since their length determines the rollover tangent, they must have a prescribed length, so that the length of both arm elements together would exceed the width of a seat related roll bar.

The older German patent application 10 2005 059 910.9 discloses a rollover protection system with a folding bar designed in a seat-related manner.

In this construction the roll bar has two bar arms spaced apart from one another in the transverse axis of the vehicle that are articulated in a pivoting manner at one end in bearings in a holder affixed to the vehicle and with their free end can be slid mutually in a folding manner and in the deployed state are linked in a reciprocally locked manner. In this way a rollover protection system is created in which the roll bar, that is the two bar arms, remain folded together in the holding position and in case of an imminent rollover the folded-together bar arms are deployed and are reciprocally locked in the deployed position.

This makes it possible, even with vehicles that have only limited space available, to integrate an effective rollover protection system with a folding arm, especially in vehicles where the space near the back rest underneath the folding arm is needed for other purposes. This is especially true in cases where space must be available for loading areas or for storing a folding roof.

DE 101 32 421 A1 discloses a rollover protection system for motor vehicles with at least one rollover body that in a normal state can be held by means of a holding mechanism in a lower, stored resting position and can be brought in a sensor-controlled manner into a deployed, locked protective position, with release of the holding mechanism by means of a drive. The rollover body has a deformation element consisting of two noble elements that can be slid into one another and reduce energy through deformation.

In protection systems with linearly deploying rollover bodies known in the prior art as well as in known active folding or swinging arms, whether designed to be seat-related or vehicle-wide, the forces generated in a rollover are deflected via corresponding bearing points into the body, because the arm systems are constructed relatively rigidly. This is especially true of the folding or swinging arm described in the aforementioned older patent application, that forms a triangle in the deployed and locked position. Therefore, due to the geometric shape of the triangle, the rigidity is very high, so that all forces are directly conducted into the pivoting bearing points of the two bar arms affixed to the body.

This complete conduction of forces into the bearing points affixed to the body can lead to stability problems in the case of folding or swinging arms, as well as in the case of linearly deploying U-shaped rollover bodies, depending on the part of the body where the bearing points are positioned or must be positioned based on the design. Deformations in the body cannot be ruled out to that extent. Also very rigid deployed arm systems can be deformed under application of great force in such a way that the lockable retraction lock and thus the protective effect of the survival area is impaired.

Deformation elements for energy reduction in the case of roll bar systems are known per se in the prior art. Thus DE 102 23 420 C1 shows a hollow deformation track deformable in a targeted manner that is affixed additionally to the bar head, and DE 101 32 421 C1 shows a system with a deformable mounting of the retraction lock. Both systems are constructed differently than in the case of the invention, and cannot be used with rollover systems with roll bars mounted in an articulated manner, as in the case of folding or swinging bars, at least not without further complications.

### BRIEF SUMMARY OF THE INVENTION

Therefore, starting from the aforementioned active linearly deploying rollover bodies as well as active folding or swinging arms that deploy by opening up, the task underlying the invention is to design them in such a way that, in case of external stressing of the respective bar, the mechanical load on the bearing points and on the retraction lock is significantly reduced.

The solution of this task, in a rollover protection system for motor vehicles with at least one rollover body that in the normal state can be held by a holding device in a lower stored resting position and that can be brought into a deployed locked support position in a sensor-controlled manner with release of the holding device by means of a drive, is achieved according to the invention in that at least one deformation element is integrated into the rollover body, formed from at least two, elastic and/or deformation-defined, energy-reducing, partial elements of the rollover body that can be slid into one another, wherein the rollover body has two bar arms, at least one of which has at least two arm elements that can be slid into one another as partial elements of the rollover body for the deformation element.

By means of the deformation element integrated into the rollover body, a defined energy reduction can be advantageously achieved in case of an external stress in a simple and yet effective manner, so that the bearing points of the respective rollover body affixed to the body are significantly relieved in terms of forces. This energy reduction in case of external stress becomes noticeable in a particularly advantageous manner in the case of a roll bar mounted in an articulated manner.

Embodiments and developments of the invention are cited in the claims below and also result from the description of the figures.

### BRIEF DESCRIPTION OF THE SEVERAL VIEWS OF THE DRAWING(S)

The foregoing summary, as well as the following detailed description of preferred embodiments of the invention, will be better understood when read in conjunction with the appended drawings. For the purpose of illustrating the invention, there is shown in the drawings embodiments, which are presently preferred. It should be understood, however, that the invention is not limited to the precise arrangements and instrumentalities shown. The invention will be further described with reference to exemplary embodiments portrayed in different views and states in the drawings:

FIG. 1 shows a front view of an actively deployable folding arm consisting of two collapsible bar arms in the deployed, locked state, with a sectional view of the driven bar arm and of the deformation element formed by it for a defined energy reduction,

FIG. 2 shows the folding bar of FIG. 1 in an isometric view, which shows in particular the spring drive for the one bar arm, as well as the manner in which the bar arms are designed and mounted,

FIG. 3 shows the folding bar in the view of FIG. 1 after a stress,

FIG. 4 shows the components of the bar arm, which forms the deformation element, in an exploded view,

FIG. 5 shows in a view analogous to FIG. 1 a folding bar with a second embodiment of the driven bar arm as a deformation element, and

FIG. 6 shows a schematic front view of a U-shaped roll bar with two parallel bar arms shown in a sectional view, both of which are designed as a deformation element analogous to the embodiment of FIGS. 1 to 4.

### DETAILED DESCRIPTION OF THE INVENTION

FIGS. 1-3 and 5 show a folding bar 1 as a rollover body of a vehicle seat-related rollover protection system for motor vehicles, that is designed in its basic construction analogous to the folding bar mentioned at the start according to the older German patent application 10 2005 059 910, the disclosure of which is hereby made part of the content of this application by reference.

This folding bar has two bar arms 2, 3 of which one end of each is articulated in a rotating manner in bearings 4 or 5 in a base frame 6 of the member affixed to a body, which can be formed by a cassette construction or a section in a cross member of the back rest of the rear passenger compartment, and of which the other ends, as will be explained below, are connected to one another in such a manner that they can be rotated and slid toward one another.

In the exemplary embodiment shown, bar arm 2 is designed as a tube and bar arm 3 is designed in a shell construction type in connection with base frame 6, so they can be folded into one another in a space-saving manner with tube-shaped bar arm 2 and received into base frame 6. However, embodiments of both bar arms are conceivable as tubes that can be moved concentrically toward one another, or component geometries that are manufactured using methods that allow the design of complex components. The bar arms can also be designed out of flat steel. In that case, they lie next to one another in the folded state.

Fixed bearings 4 or 5 absorb the forces generated in a rollover and deflect them into the body. Therefore they must be of correspondingly thick dimension and fastened in base frame 6. For this purpose, corresponding bearing blocks 6a, 6b are positioned on the base frame.

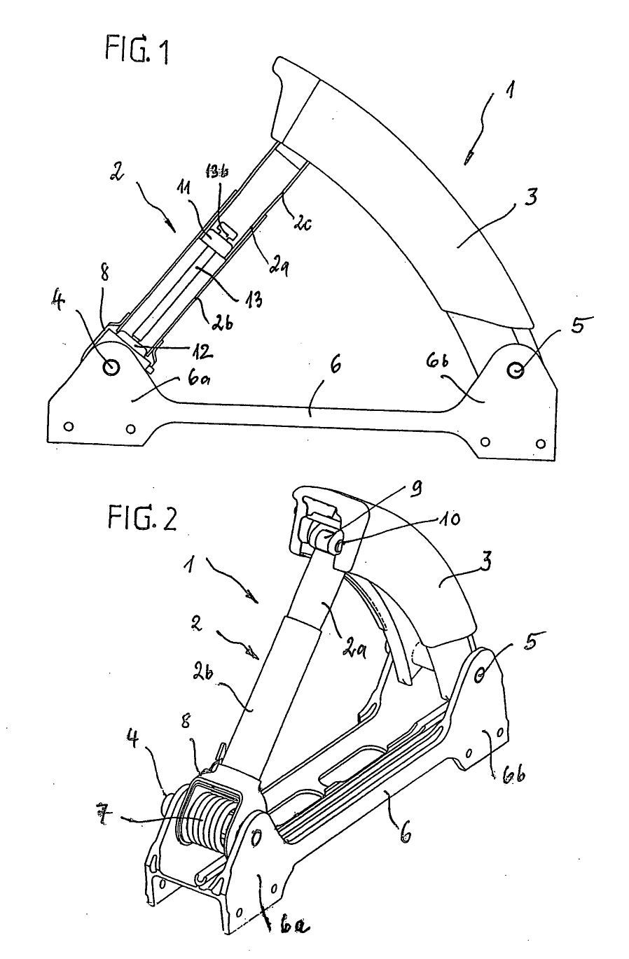

For the deployment of the folding bar, a drive pressure spring 7, here in the form of a torsion spring or spiral spring is provided that, as shown in particular in FIG. 2, is connected at one end in a triggerable fashion to a cage like bearing housing 8, which is connected with the free end of the driven bar arm 2, and braces itself with the other end against base frame 6. However, the arrangement can also be made such that a drive spring is assigned to each of the two bar arms 2, 3. In place of a pressure spring in the form of a torsion spring, a helical spring or the like can also be provided.

In the collapsed, i.e. stored, resting position (not shown) of folding bar 1, drive spring 7 is under spring tension. The folding bar is held in this position by a releasable holding device, likewise not shown in a visible manner. A number of constructions are conceivable for this holding device, which are known in particular from the relevant prior art, especially from the aforementioned older German patent application. The holding device is in active connection with an actuator affixed to the body, that can be formed by an electromagnetic or pyrotechnic actuator.

If the actuator is activated in the case of an imminent rollover in a sensor-controlled manner, it triggers the holding device, causing drive spring 7 to deploy driven bar arm 2, which then pulls up non-driven bar arm 3. This “pulling up together” occurs due to the special type of connection of the two bar arms 2, 3. As shown in FIG. 2, to the front end of driven bar arm 2 a locking unit 9 is attached that can be designed, for example, analogous to the one in the older German application, which is held in a slidable manner in a link 10 designed on the inside in bar arm 3 that is moved in tandem. In the stored state, this unit is located at the lower end of the link of non-driven bar arm 3. When drive spring 7 deploys bar arm 2, the locking unit pulls other bar arm 3 with it via link 10, until the deployed position according to FIGS. 1, 2 and 5 is reached. In this position the locking unit snaps in, so that the deployed bar arms cannot be pushed in during a rollover (retraction lock).

Obviously, other locking mechanisms known in principle, such as a ratchet lock in connection with tooth segments can also be used.

In the deployed state, two bar arms 2, 3 form a triangle together with base frame 6. Through this triangular configuration and the rotating mounting of the bar arms, the latter act as pressure rods and can accordingly transmit very high pressure forces into the vehicle structure.

On the other hand, due to this triangular configuration, the folding bar is also very rigid, which can lead to the stability problems at the bearing points explained at the start. In order to prevent this, driven bar arm 2 is designed as a deformation element with energy reduction due to plastic deformation. It has two partial tubes that can be slid into one another, an inner tube 2a and an outer tube 2b. Both partial tubes are in principle not limited to a specific geometric shape. Thus round and angular profiles of every shape are conceivable in cross-section.

As shown in FIGS. 1, 3 and 4 in particular, inner tube 2a has at its free end a diffuser-like expanded conical section 2c, to the outlet of which locking unit 9 is attached. At the other end, a pot-shaped guide element 11 with a central opening in the pot floor is firmly attached using conventional fastening methods.

Outer tube 2b has a constant cross-section over its length, takes in inner tube 2a in a slidable fashion via its upper end, and is fastened at its other and into cage like bearing housing 8. In this area near the end, a threaded element 12 is attached, preferably welded on.

This threaded element can be realized in various ways. For example, it can be designed as a pot-shaped sheet-metal molded part. On the floor of the pot there is a central opening. Coaxially to this opening, a weld nut is affixed to the inner side of the pot floor. However, a wide variety of other shapes are conceivable as well as other types of material. For example, a commercially available nut can also be connected flush and/or mate with the outer tube or else a plastic nut can be glued in. The attachment of a threaded plate is also conceivable.

The side of inner tube 2a facing away from cone 2c, thus the side on which the welded-on guide element 11 is located, is slid into the open end of outer tube 2b, until the outer wall of cone 2c of inner tube 2a touches the inner wall of outer tube 2b.

In addition, a rod-shaped or screw-like pull element 13 is provided at its lower end with a threaded section 13a and with an upper end 13b designed like a screw head, which in the assembled state penetrates guide element 11 in a sliding manner via its opening in the pot floor and is screwed into threaded element 12 with its lower threaded section 13a. The screwing-in occurs, for example, by means of a corresponding design of the screw head-like end 13b of the pull element using a tool, for example a hex key. The screwing is done until the inner tube has been tightened against the outer tube with no play.

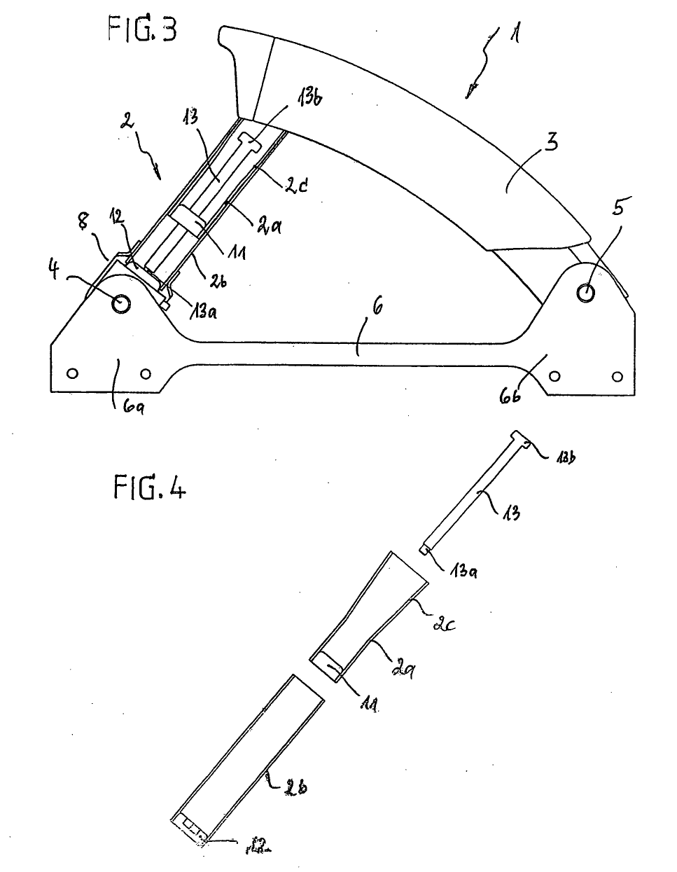

This so-called basic position is shown in FIGS. 1 and 2 in the deployed state of folding bar 1. When a rollover occurs, a large force is applied to the non-driven bar arm 3, which pushes inner tube 2a into outer tube 2b of the driven bar arm. During the pushing-in process, the opening of guide element 11 near the floor glides along pull element 13, which prevents buckling of the two tubes 2a, 2b and provides for guiding of inner tube 2a. Through the sliding of tubes 2a, 2b into one another, outer tube 2b is deformed by cone 2c of inner tube 2a with reduction of energy, i.e. it is plasticly deformed. The process is limited by the complete submersion of the tubes into one another. This state is shown in FIG. 3. As can be seen, the folding bar has of course been buckled slightly by the crash, but it is nonetheless effective, i.e. it creates a survival tangent.

A detachment of the system is prevented by pull element 13 located inside of tubes 2a, 2b, which can absorb pulling forces, i.e. in case of pulling stress the energy from the “pulling arrangement” is absorbed in the inside. Namely, if the pulling stress comes onto the system, for example in a rescue attempt, pull element 13 takes over the force transfer. In a rescue attempt, it is simulated that a tow truck pulls the vehicle out of the ditch and the towing hook is hooked into the triangle of the folding bar. If the pull element were not present, inner tube 2a would be pulled out of outer tube 2b. This way, however, head 13b of pull element 13 is used as a stop. In this stress case, the underside of head 13b forms the stop with the underside of pot-shaped guide element 11. Since the pull element is part of outer tube 2b through the screwed-in end 13a and guide element 11 is part of inner tube 2a, both tubes 2a, 2b cannot be pulled apart.

The system encompasses a wide range of force levels to be absorbed. The shape of the tube cross section can be selected freely. In addition, a precise design of the system can be adapted using geometric modifications; of which the following can be mentioned: slant of the cone, wall thickness of the tubes used, surface characteristics of the tubes, quality of the material used.

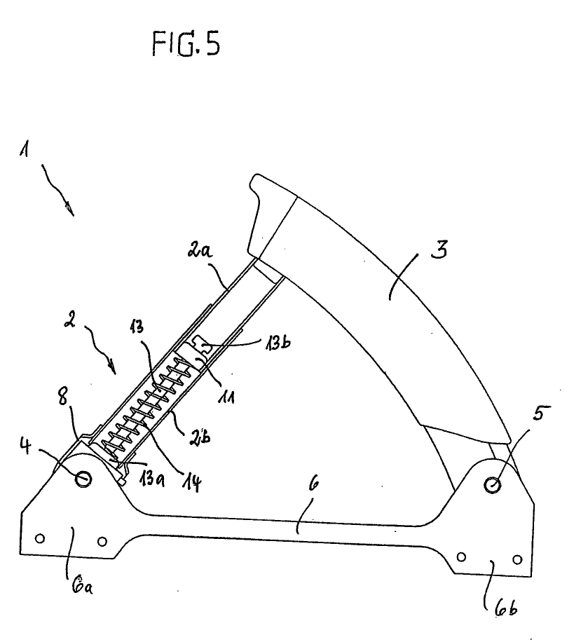

In another embodiment, in place of a plastic deformation by a cone on inner tube 2a, the deformation element according to the invention can also have a strong helical spring in the driven bar arm 2 for an elastic deformation. FIG. 5 shows this type of embodiment. Functioning as a spring guide rod, pull element 13 holds a helical spring 14 designed for pressure, which braces with one end against pot-shaped guide element 11 and with the other end against threaded element 12. Under stress conditions, inner tube 2a, which has a persistent constant cross-section, compresses helical spring 14 via guide element 11, so that the required compression work causes energy reduction.

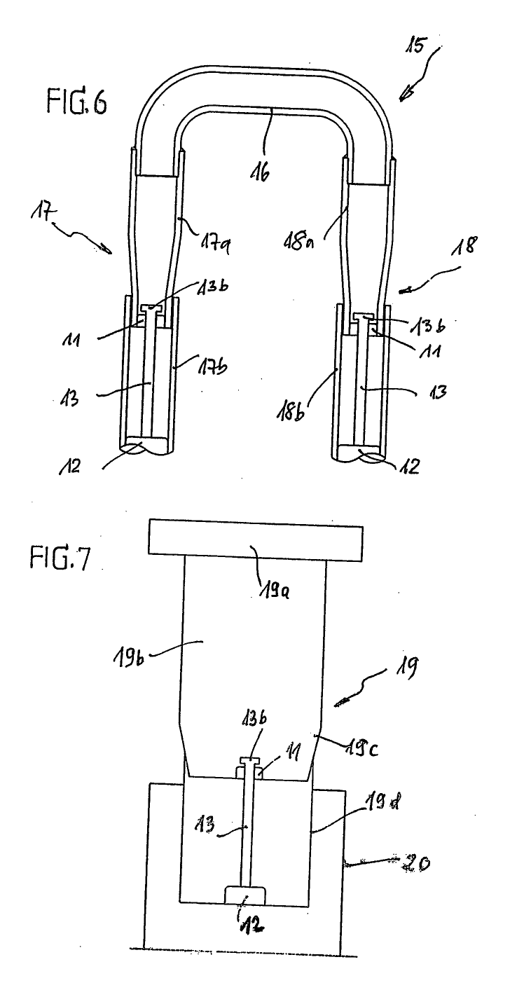

FIGS. 1-5 show a rollover body designed as folding bar 1. The energy-reducing deformation element integrated into the rollover body can also be used with other rollover bodies as shown in FIG. 6.

Thus FIG. 6 shows an embodiment with a U-shaped rollover bar 15, that has a rounded bar head 16 and two tube-shaped bar arms 17, 18 running parallel to one another, which are connected, in particular welded, at the head with bar head 16. Each bar arm has two tube segments that can be slid into one another, an inner tube 17a or 18a and an outer tube 17b or 18b.

Inner tubes 17a or 18a of the two bar arms are designed conically, whereas outer tubes 17b, 18b have a constant cross-section. Otherwise, what was said about the design of the corresponding tubes for the folding bar of FIG. 1 is applicable analogously.

Inside of arm tubes 17, 18, which are segmented in two pieces, a pull mechanism according to FIG. 4 is positioned, and reference is hereby made to the description thereof. The method of action of the two deformation elements of the U-shaped rollover bar 15 corresponds to the described method of action of the driven bar arm 2 of folding bar 1, i.e. the energy absorption occurs via a plastic deformation of inner tubes 17a or 18a or also of outer tubes 17b, 18b.

### LIST OF REFERENCE SIGNS

1 Folding bar

2 Driven bar arm

2a Inner tube

2b Outer tube

2c Conical section

3 Non-driven bar arm

4 Bearing (of the driven bar arm)

5 Bearing (of the non-driven bar arm)

6 Base frame

6a, b Bearing blocks

7 Drive torsion spring

8 Cage like bearing housing

9 Locking unit

10 Link

11 Guide element

12 Threaded element

13 Pull element

13a Threaded section

13b Screw head-like end

14 Helical spring

15 U-shaped rollover bar

16 Rounded bar head

17, 18 Bar arm

17a, 18a Inner tube

17b, 18b Outer tube

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. A rollover protection system for motor vehicles with at least one rollover body that in the normal state can be held by a holding device in a lower stored resting position and that can be brought into a deployed locked support position in a sensor-controlled manner with release of the holding device by means of a drive, the system comprising at least one deformation element integrated into a rollover body, formed from at least two elastic and/or plastic deformation-defined, energy-reducing, partial elements of the rollover body that can be slid into one another, and which has two bar arms, at least one of which comprises at least two arm elements that can be slid into one another as partial elements of the rollover body for the deformation element.

2. The rollover protection system of claim 1, wherein both bar arms are formed from two arm elements that can be slid into one another.

3. The rollover protection system of claim 1, wherein only the one bar arm is in a driving active contact with the drive and that only this one is formed from at least two arm elements.

4. The rollover protection system of claim 1, wherein at least one partial arm element is designed in a cone-like shape for plastic deformation.

5. The rollover protection system of claim 1, wherein the partial arm elements are designed in a tube shape, with an inner tube that is taken up in an axially slidable manner into an outer tube of adapted diameter.

6. The rollover protection system of claim 5, wherein inner the tube has a cone-like expanded outer end section.

7. The rollover protection system of claim 5, wherein both the inner tube as well as the outer tube of greater diameter have a constant diameter along their length, and between the inserted end of inner tube and the foot end of outer tube a spring is inserted that can be stressed by compression and reduce energy.

8. The rollover protection system of claim 1, wherein the rollover body is designed as a folding bar, which has two bar arms spaced apart from one another along a transverse axis of the vehicle that are articulated in a pivoting manner at one end in bearings in a base frame affixed to the vehicle and with their free end can be slid mutually in a folding manner and in the deployed state are linked in a reciprocally locked manner.

9. The rollover protection system of claim 1, wherein the rollover body is designed as a U-shaped rollover bar.

10. The rollover protection system of claim 1, wherein the partial elements of the deformation element are linked to one another via a pull element in such a way that they can withstand pulling stress.

11. The rollover protection system of claim 10, wherein the pull element is formed of a screw with a head and least one lower threaded section, and both partial elements each have an additional component at the end opposite the end inserted into one another with a threaded element for screwing in the threaded section and a guide element as a stop that has an opening for penetration by the screw shaft.

12. The rollover protection system of claim 11, wherein the additional components are designed in a pot-shaped manner.
